(19) United States
(12) Patent Application Publication
(10) Pub. No.: US 2025/0136866 A1
(43) Pub. Date: May 1, 2025

(54) WOOD MULCH AGENT DELIVERY

(71) Applicant: Robert E. SANDSTROM, Longview, WA (US)

(72) Inventor: Robert E. SANDSTROM, Longview, WA (US)

(21) Appl. No.: 19/002,427

(22) Filed: Dec. 26, 2024

Related U.S. Application Data
(63) Continuation-in-part of application No. 17/385,837, filed on Jul. 26, 2021.
(60) Provisional application No. 63/056,346, filed on Jul. 24, 2020.

(51) Int. Cl. C09K 17/52; A01N 25/26; A01N 37/34; A01N 43/653; A01N 57/16; A01P 3/00; A01P 7/04; A62D 1/00; B27K 3/34; C09K 21/04

(52) U.S. Cl. CPC C09K 17/52; A01N 25/26; A01N 37/34; A01N 43/653; A01N 57/16; A01P 3/00; A01P 7/04; A62D 1/0007; C09K 21/04; B27K 3/343; B27K 2240/20; B27K 2240/30

(57) ABSTRACT

Methods of applying an agent to an area, such as methods of applying an agent to an area under cultivation, including providing wood fragments that have been treated to absorb the agent, and dispersing the wood fragments about the area under cultivation; methods of creating a fire-resistant area, including providing wood fragments that have been treated to absorb a fire retardant, and dispersing the wood fragments in an area to create the fire-resistant area; and methods of fighting a fire, including providing wood fragments that have been treated to absorb a fire retardant, and dispersing the wood fragments onto the fire.

### CROSS-REFERENCE TO RELATED APPLICATIONS

This application is a continuation-in-part application of U.S. patent application Ser. No. 17/385,837, filed Jul. 26, 2021, and claims the benefit of priority of U.S. provisional patent application Ser. No. 63/056,346, filed Jul. 24, 2020, each of which applications is hereby incorporated by reference for all purposes.

### TECHNICAL FIELD

The present disclosure relates to landscaping materials, such as mulching materials. More particularly, the present disclosure relates to dispersing an agent using wood-based mulching materials that incorporate the agent.

### BACKGROUND

The application of a liquid to an area can be problematic. Even if rendered as a fine spray, there are nevertheless issues with runoff, particularly when encountering surfaces that are nonabsorbent and hydrophobic. Achieving controlled dispersal of a liquid agent can also present a challenge.

One problematic area of liquids application is that of applying pesticides, fungicides, and herbicides in agriculture. The effects of such an application might quickly dissipate, due to the rapid absorption and/or runoff of the liquids applied. Consequently, more frequent application of more dilute agents may be required, thereby requiring a greater effort.

Also, applying liquid fire retardant to a wildfire may present difficulties, particularly in achieving beneficial dispersal about the fire. A liquid will tend to drop immediately without a great deal of dispersal.

Cedar chips naturally release phenolic compounds which are toxic and/or repel insects and a range of animals to include mice. Cedar has been particularly well studied as a soil modifier, and cedar chips acting as natural diffusers can be employed as soil modifiers to enhance soil pH, metallic ion concentration, and other beneficial nutritional characteristics.

Cedar derived chips and particulates have been demonstrated to improve soil quality and enhance growth when layered or admixed with soil. Among others Dessolas Guy patented the application of bark, specifically coconut bark, for consolidation and improvement of soil as a growth medium. Chipped wood, as a substrate for plant growth and a moisturizing agent has been proposed and patented by DRIWATER and others.

Cedar bark is used widely as ground cover in the form of chips, and is widely available in the United States. The absorption of heavy metals by cedar bark and other wood chips has been documented. Cedar bark absorbs organic liquids including animal urine and has been suggested as a bedding material for domestic animals.

### SUMMARY

The following embodiments and aspects thereof are described and illustrated in conjunction with systems, tools, and methods which are meant to be exemplary and illustrative, not limiting in scope. In various embodiments, one or more of the above-described problems have been reduced or eliminated, while other embodiments are directed to other improvements.

In one example, the present disclosure includes a method of applying an agent to an area under cultivation, including providing wood fragments that have been treated to absorb the agent, where the wood fragments are wood particles having an average major axis length less than 5 mm; and dispersing the wood fragments about the area under cultivation.

In another example, the present disclosure includes a method of creating a fire-resistant area, including providing wood fragments that have been treated to absorb a fire retardant, where the wood fragments are wood particles having an average major axis length less than 5 mm; and dispersing the wood fragments in an area to create the fire-resistant area.

In another example, the present disclosure includes a method of fighting a fire, including providing wood fragments that have been treated to absorb a fire retardant, where the wood fragments are wood particles having an average major axis length less than 5 mm; and dispersing the wood fragments onto the fire.

### BRIEF DESCRIPTION OF THE DRAWINGS

FIG. 1 is a flowchart illustrating an exemplary method according to the present disclosure.

FIG. 2 is a flowchart illustrating an alternative exemplary method according to the present disclosure.

FIG. 3 is a flowchart illustrating an alternative exemplary method according to the present disclosure.

### DETAILED DESCRIPTION OF PREFERRED EMBODIMENTS

The following is a detailed description of selected exemplary embodiments to illustrate the principles of the present invention. The embodiments are provided to illustrate selected aspects of the disclosure, but the invention is not limited to any particular embodiment. The scope of the disclosure encompasses numerous alternatives, modifications and equivalent; and the scope of the invention is limited only by the claims.

Numerous specific details are set forth in the following description in order to provide a thorough understanding of the present disclosure. However, the methods of the present disclosure may be practiced according to the claims without some or all of these specific details. For the purpose of clarity, technical material that is known in the technical fields related to the invention has not been described in detail so that the disclosure is not unnecessarily obscured.

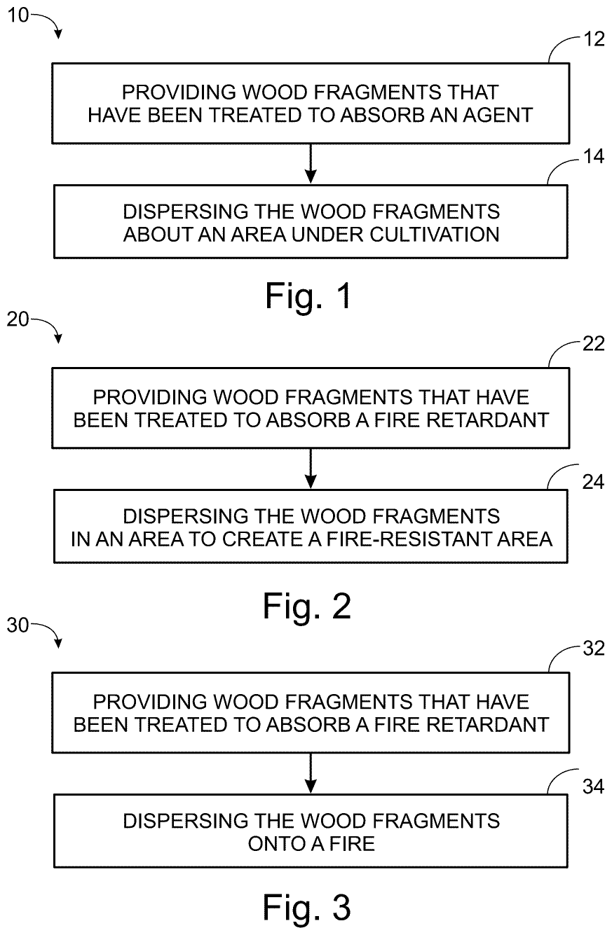

In one example, the methods of the present disclosure include methods of applying a desired agent to an area under cultivation, as set out in flowchart 10 of FIG. 1. The method includes providing wood fragments that have been treated to absorb the agent, where the wood fragments are wood particles having an average major axis length of less than 5 mm, at step 12 of flowchart 10; and dispersing the wood fragments about the area under cultivation, at step 14 of flowchart 10.

The particular variety of wood used to prepare the wood fragments of the disclosure is not critical, and any type of wood that can be used to successful apply the desired agent is a wood that is useful for the present disclosure. In one aspect, a wood that possesses naturally advantageous properties for plant cultivation, such as cedar, is used to prepare the wood fragments of the disclosure.

The wood fragments of the disclosure can include any appropriate size and shape of wood fragment, such as bark fragments, sawdust, and wood chips. The size of the wood fragments should be selected so that the agent of interest can be readily absorbed by, or adsorbed onto, the wood fragments.

The methods of the present disclosure may be used to apply one or more agents, such as chemical agents, to the soil in an area in which plants are growing, or will be growing. The present methods may be useful for the treatment of soil for the benefit of any suitable plant type, including but not limited to flowering shrubs; flowering plants; decorative plants; crop plants such as grains, fruits, and vegetables; and trees.

While the liquid absorption capacity of the wood fragments, as well as the addition of organic matter, can directly benefit the health of a soil treated with the wood fragments, the present methods have particular utility in permitting the application of a desired agent to the soil by applying wood fragments that have been immersed or exposed to the desired agent, so that the wood fragments have absorbed and/or adsorbed the desired agent. The application of such treated wood fragments thereby acts as an application method for the desired agent itself.

Chip size and surface area may be adjusted by the chipping methods employed to manufacture the wood fragments. Any suitable wood chipping equipment may be used to manufacture the wood fragments, such as disc chippers, drum chippers, among others. In addition to the chipping mechanism itself, the morphologies and size distributions of manufactured wood fragments can be selected by the use of wood feed stock having a selected moisture content, or that is frozen before chipping, or by selection of the wood species used.

Typically, the wood fragment manufacture method is selected so as to produce wood fragments having improved absorbance or adsorbance characteristics, so that the process of combining the desired agent with the wood fragments is more efficient, more economical, and results in an optimized application rate of the desired agent in a minimum of wood fragments. The degree to which the wood particles absorb or adsorb a desired agent, such as selected organic compound or selected non-organic compound, can be optimized by the choice of a combination of solvent selection, applied pressure, and temperature. Further, the choice of particle size and relative surface geometry may be chosen to provide optimal absorption of the agent, and later release of the agent, for a given application. In general, particles having a smaller volume exhibit an increased ratio of surface area-to-volume. That is, the use of smaller wood fragments can result in both enhanced absorbance and enhanced adsorbance of the desired agent, as well as enhancing the methods of the agent's application to the wood fragments. It can be advantageous, therefore, to employ smaller wood fragments, such as wood fragments having an average major axis length of 5 mm, preferably 2 mm, and more preferably 1 mm.

The wood fragments may be loaded with a desired agent (or chemical agent) that is used in or useful for agriculture or horticulture. The wood fragments may be loaded with a single desired agent, or a blend of two or more desired agents, in any suitable ratio. The desired agent may be an agent for improving soil quality, such as a fertilizing agent. Alternatively, or in addition, the desired agent may be an agent for treating and/or preventing a plant illness or infestation, such as an insecticide, a fungicide, or an appropriate herbicide (i.e., a herbicide selected to be safe for application to a desired plant type). Selected examples of such agents include diazinon for the treatment of insect plant pathogens, tebuconazole for the treatment of fungal diseases in plants, and chlorothalonil for treating plant rust, blights and mildew, among many others.

In a particularly advantageous method of the present disclosure, the wood fragments are immersed or exposed to chemicals commonly employed as fire retardants. The fire retardant agent may be selected because the fire retardant agent reduces the flammability of fuels, or delays their combustion. Some selected fire retardant agent may also cool the fuel through physical action or endothermic chemical reactions. Fire retardant agents may be absorbed by and/or adsorbed on the wood fragments in any suitable manner, such as direct absorbance where the fire retardant agent is a liquid. Alternatively, or in addition, a fire retardant may be mixed or dissolved in water or other solvent and applied to the wood fragments.

A selected fire retardant agent may include, for example, mixtures of huntite and hydromagnesite, aluminum hydroxide, magnesium hydroxide, boron compounds, ammonium pyrophosphate, or other novel fire retardant agents.

Where the wood fragments are treated with a boron compound as a fire retardant agent, the process typically includes treating the wood fragments with a selected boron compound, such as borax, or boric acid. In addition to exhibiting fire retardant properties, wood fragments treated with boron compounds may also possess utility for use as a fungicide or insecticide.

The methods of the present disclosure include methods of creating a fire-resistant area, as set out in flowchart 20 of FIG. 2. The method includes providing wood fragments that have been treated to absorb a fire retardant, where the wood fragments are wood particles having an average major axis length of less than 5 mm, at step 22 of flowchart 20; and dispersing the wood fragments in an area to create the fire-resistant area, at step 24 of flowchart 20.

The methods of the present disclosure further include methods of fighting a fire, as set out in flowchart 30 of FIG. 3. The method includes providing wood fragments that have been treated to absorb a fire retardant, where the wood fragments are wood particles having an average major axis length of less than 5 mm, at step 32 of flowchart 30; and dispersing the wood fragments onto the fire, at step 34 of flowchart 30.

Where the wood fragments are treated with a fire retardant agent, the wood fragments may be particularly useful for covering selected roads or trails, in order to provide a longer term fire barrier. Alternatively, the wood fragments may be in the form of a fine dust, that is, having a very small particle size, such as having an average major axis length of 5 mm, preferably 2 mm, and more preferably 1 mm. By employing such fine powder-sized wood fragments, the wood fragments have a higher relative fire retardant agent absorption, due to their larger surface area to volume ratio, and such fine wood fragments can be readily dispersed in high-risk fire environments in order to mitigate fire risk. Alternatively, or in addition, the fire retardant-treated wood fragments may be dispersed onto an active fire, for example by an airborne vehicle such as a helicopter, airplane, or unmanned drone. In an alternative example, the fire retardant-treated wood fragments may be dispersed by an air blower system, including a wide hose through which the wood fragments are pushed by a stream of air.

The disclosed embodiments are illustrative, not restrictive. While specific configurations of the wood fragment agent delivery have been described, it is understood that the present invention can be applied to a wide variety of delivery techniques, and there are many alternative ways of implementing the invention.

The subject matter of the present disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the present disclosure.

What is claimed is:

1. A method of applying an agent to an area under cultivation, comprising:
a) providing wood fragments that have been treated to absorb the agent, wherein the wood fragments are wood particles having an average major axis length of less than 5 mm; and
b) dispersing the wood fragments about the area under cultivation.

2. The method of claim 1, wherein the wood fragments are cedar wood fragments.

3. The method of claim 1, wherein the wood fragments are wood particles, having an average major axis length of less than 2 mm.

4. The method of claim 1, wherein the wood fragments are wood particles, having an average major axis length of less than 1 mm.

5. The method of claim 1, wherein the agent is a pesticide.

6. The method of 5, wherein the pesticide is diazinon.

7. The method of claim 1, wherein the agent is a fungicide.

8. The method of claim 7, wherein the fungicide is tebuconazole.

9. The method of claim 7, wherein the fungicide is chlorothalonil.

10. A method of creating a fire-resistant area, comprising:
a) providing wood fragments that have been treated to absorb a fire retardant, wherein the wood fragments are wood particles having an average major axis length of less than 5 mm; and
b) dispersing the wood fragments in an area to create the fire-resistant area.

11. The method of claim 10, wherein the wood fragments are dispersed from an airborne vehicle.

12. The method of claim 10, wherein the wood fragments have been treated to absorb ammonium pyrophosphate.

13. The method of claim 10, wherein the wood fragments have been treated to absorb a boron compound.

14. The method of claim 10, wherein the wood fragments are wood particles having an average major axis length of less than 2 mm.

15. The method of claim 10, wherein the wood fragments are wood particles having an average major axis length of less than 1 mm.

16. The method of claim 10, wherein dispersing the wood fragments includes dispersing the wood fragments with an air blower system including a wide hose blower.

17. A method of fighting a fire, comprising:
a) providing wood fragments that have been treated to absorb a fire retardant; wherein the wood fragments are wood particles having an average major axis length of less than 5 mm; and
b) dispersing the wood fragments onto the fire.

18. The method of claim 17, wherein the wood fragments are dispersed from an airborne vehicle.

19. The method of claim 17, wherein the fire retardant-bearing wood fragments are treated with ammonium pyrophosphate.

20. The method of claim 17, wherein the fire retardant-bearing wood fragments are treated with a boron compound.
